(19) United States
(12) Patent Application Publication
(10) Pub. No.: US 2011/0176742 A1
(43) Pub. Date: Jul. 21, 2011

(54) Image processing apparatus and image processing method

(75) Inventors: Takahiro Fukuhara, Kanagawa (JP); Hiroshi Akinaga, Kanagawa (JP)

(73) Assignee: Sony Corporation, Tokyo (JP)

(21) Appl. No.: 12/930,416

(22) Filed: Jan. 6, 2011

(30) Foreign Application Priority Data
Jan. 18, 2010 (JP) P2010-007807

(51) Int. Cl. G06K 9/36

(52) U.S. Cl. 382/248; 382/232

(57) ABSTRACT

An image processing apparatus is disclosed which includes: an analysis filtering section configured to transform a line block into coefficient data decomposed into frequency bands by performing an analysis filtering process hierarchically, the line block including image data of as many lines as needed for generating the coefficient data of at least one line in a subband of the lowest-frequency component; an encoding section configured to encode the coefficient data generated by the analysis filtering section; and an alignment section configured to align, in increments of a predetermined data length, the encoded data obtained by encoding the coefficient data by the encoding section.

### CROSS-REFERENCE TO RELATED APPLICATION

The present application claims priority from Japanese Patent Application No. JP 2010-007807 filed in the Japanese Patent Office on Jan. 18, 2010, the entire content of which is incorporated herein by reference.

### BACKGROUND OF THE INVENTION

1. Field of the Invention

The present invention relates to an image processing apparatus and an image processing method. More particularly, the invention relates to an image processing apparatus and an image processing method for more easily implementing a low-delay data transmission setup that improves the tolerance to the loss of packets during data transmission thereby suppressing image quality degradation.

2. Description of the Related Art

Representative image compression methods today include the JPEG (Joint Photographic Experts Group) and JPEG 2000 standards standardized by the ISO (International Standards Organization).

In recent years, progress has been made in the study of methods for dividing images into a plurality of bands using a so-called filter bank combining a high-pass filter and a low-pass filter, thereby encoding the divided images in increments of a band. Of these methods, wavelet transform encoding is regarded as a promising candidate to replace DCT (discrete cosine transform). That is because wavelet transform encoding is free from block distortion, which is a problem characteristic of DCT, stemming from high data compression.

The JPEG 2000, internationally standardized in January 2001, adopts the scheme of combining wavelet transform with a highly efficient entropy encoding method (involving bit modeling and arithmetic coding in increments of a bit plane). This scheme offers a significantly higher improvement in terms of encoding efficiency than the JPEG.

Also, the JPEG 2000 has been selected as a standard codec for the DCI (Digital Cinema Initiative). As such, the JPEG 2000 has started to be utilized for compressing moving images such as those of movies. Manufacturers have begun introducing security cameras, news-gathering cameras for use by broadcasting stations, security recorders, and other products based on the JPEG 2000.

However, the JPEG 2000 basically stipulates the specifications for regulating the encoding and decoding of data in increments of a picture. Thus if a low-delay setup is to be realized for real-time data transmission and reception, a delay of at least one picture is bound to occur during encoding as well as during decoding.

The bottleneck above applies not only to the codecs complying with the JPEG 2000 but also to AVC (Advanced Video Coding)-Intra and JPEG-based codecs. Recently, however, proposals have been made for shortening the delay time by dividing each picture into several rectangular slices or tiles and by encoding and decoding these portions independently of one another (e.g., see Japanese Patent Laid-Open No. 2006-311327).

The JPEG 2000 has scalability in terms of resolution and image quality. This functionality is implemented thanks to wavelet transform adopted by the JPEG 2000. For example, with regard to resolution scalability, wavelet transform involves generating a plurality of subbands during the process of repeatedly resolving images in the low-frequency direction. These subbands are composited successively from the low-frequency component upward, whereby images of multiple sizes are obtained.

The above characteristics of the JPEG 2000 may be utilized in conducting communications via unstable transmission channels such as the Internet. Given the above-outlined feature of the JPEG 2000 regarding resolution scalability, it can be said that the lower the frequency of the subbands, the more significantly they affect the quality of decoded images. It follows that the earlier (i.e., the more preferentially) the lower-frequency component subbands are transmitted, the longer the tolerable time that can be secured for retransmission control to deal with packet losses on the network, particularly in the low-frequency component domain.

That is, the more subbands are in the low-frequency component domain, the more securely they can be transmitted. Since the low-frequency component subbands alone can reconstitute the overall feature of images, failing to transmit high-frequency component subbands will not result in the failure to display an entire image as has been the case with traditional codecs.

### SUMMARY OF THE INVENTION

In the case above, however, it is necessary for the receiving side to carry out such processes as compositing and discarding of received data in increments of a subband. That is, the receiving side needs to detect the boundaries of subbands, which has proved to be a difficult exercise in the current state of the art.

The present invention has been made in view of the above circumstances and provides inventive arrangements for more easily implementing a low-delay data transmission setup that improves the tolerance to the loss of packets during data transmission thereby suppressing image quality degradation.

In carrying out the present invention and according to one embodiment thereof, there is provided an image processing apparatus including: analysis filtering means for transforming a line block into coefficient data decomposed into frequency bands by performing an analysis filtering process hierarchically, the line block including image data of as many lines as needed for generating the coefficient data of at least one line in a subband of the lowest-frequency component; encoding means for encoding the coefficient data generated by the analysis filtering means; and alignment means for aligning, in increments of a predetermined data length, the encoded data obtained by encoding the coefficient data by the encoding means.

Preferably, the image processing apparatus may further include encoded data reordering means for reordering the encoded data from the order in which an output stemming from the analysis filtering process was carried out by the analysis filtering means, to an order in which the encoded data is ordered from the lowest-frequency component upward.

According to another embodiment of the present invention, there is provided an image processing method for use with an image processing apparatus having analysis filtering means, encoding means and alignment means. The image processing method includes the steps of: causing the analysis filtering means of the image processing apparatus to transform a line block into coefficient data decomposed into frequency bands by performing an analysis filtering process hierarchically, the line block including image data of as many lines as needed for generating the coefficient data of at least one line in a subband of the lowest-frequency component; causing the encoding means of the image processing apparatus to encode the generated coefficient data; and causing the alignment means of the image processing apparatus to align, in increments of a predetermined data length, the encoded data obtained by encoding the coefficient data.

According to a further embodiment of the present invention, there is provided an image processing apparatus including: determination means for determining a data alignment length constituting the data length by which to align encoded data generated by encoding a line block made up of a group of coefficient data in subbands including at least one line of coefficient data in a subband of the lowest-frequency component, the coefficient data being composed of image data of a predetermined number of lines decomposed into frequency bands by performing an analysis filtering process hierarchically; alignment means for aligning the encoded data in increments of the data alignment length determined by the determination means; storage means for storing the encoded data aligned by the alignment means; read means for detecting from the encoded data in the storage means boundaries of align units each serving as a data unit by which to decompose the encoded data into division levels of the analysis filtering process, the read means further reading only the encoded data of a necessary align unit from the storage means in increments of the data alignment length; and decoding means for decoding the encoded data read by the read means from the storage means.

Preferably, the image processing apparatus may further include composite filter means for transforming the coefficient data in subbands into the image by carrying out a composite filtering process hierarchically, the coefficient data in subbands having been obtained by the decoding means through decoding.

Preferably, the image processing apparatus may further include count means for counting the number of pixels of the coefficient data in subbands obtained by the decoding means through decoding; wherein the decoding means may transform the coefficient data in subbands into the image data based on the boundaries of the align units detected in accordance with the number of pixels counted by the count means.

Preferably, the determination means may determine the data alignment length based on whether or not the align units exist in the encoded data, on whether or not the encoded data has been aligned previously, and on the bit width of a transmission channel on which the encoded data is transmitted.

Preferably, if the align units are found to exist in the encoded data and if the encoded is found to have been aligned previously, then the determination means may determine the data alignment length used in the previous alignment as the data alignment length.

Preferably, if the align units are found to exist in the encoded data and if the encoded data is not found to have been aligned previously, then the determination means may determine the bit width of the transmission channel as the data alignment length.

Preferably, if the align units are not found to exist in the encoded data, then the determination means may determine the data alignment length as zero bit.

According to an even further embodiment of the present invention, there is provided an image processing method for use with an image processing apparatus having determination means, alignment means, storage means, read means and decoding means, the image processing method including the steps of: causing the determination means of the image processing apparatus to determine a data alignment length constituting the data length by which to align encoded data generated by encoding a line block made up of a group of coefficient data in subbands including at least one line of coefficient data in a subband of the lowest-frequency component, the coefficient data being composed of image data of a predetermined number of lines decomposed into frequency bands by performing an analysis filtering process hierarchically; causing the alignment means of the image processing apparatus to align the encoded data in increments of the data alignment length having been determined; causing the storage means of the image processing apparatus to store the encoded data having been aligned; causing the read means of the image processing apparatus to detect from the stored encoded data boundaries of align units each serving as a data unit by which to decompose the encoded data into division levels of the analysis filtering process, the read means being further caused to read only the encoded data of a necessary align unit in increments of the data alignment length; and causing the decoding means of the image processing apparatus to decode the encoded data having been read.

Where the present invention is practiced in one way as outlined above, a line block is transformed into coefficient data decomposed into frequency bands by performing an analysis filtering process hierarchically, the line block including image data of as many lines as needed for generating the coefficient data of at least one line in a subband of the lowest-frequency component. The coefficient data thus generated is encoded. The encoded data obtained by encoding the coefficient data is then aligned in increments of a predetermined data length.

Where the present invention is practiced in another way as outlined above, a data alignment length is determined which constitutes the data length by which to align encoded data generated by encoding a line block made up of a group of coefficient data in subbands including at least one line of coefficient data in a subband of the lowest-frequency component, the coefficient data being composed of image data of a predetermined number of lines decomposed into frequency bands by performing an analysis filtering process hierarchically. The encoded data is aligned in increments of the determined data alignment length. The encoded data thus aligned is then stored. From the encoded data in storage, boundaries of align units are detected, each align unit serving as a data unit by which to decompose the encoded data into division levels of the analysis filtering process. Only the encoded data of a necessary align unit is read out in increments of the data alignment length. The encoded data thus read out is decoded.

As outlined above, the embodiments of the present invention process images. In particular, the embodiments realize more easily a low-delay data transmission setup in a manner suppressing image quality degradation attributable to irregularities that may occur during data transmission.

### BRIEF DESCRIPTION OF THE DRAWINGS

FIG. 1 is a block diagram showing a major configuration example of a transmission/reception system to which the present invention is applied;

FIG. 2 is a block diagram showing a major configuration example of a transmission apparatus included in FIG. 1;

FIG. 3 is a schematic view explanatory of subbands and line blocks;

FIG. 4 is a schematic view showing a typical 5×3 filter;

FIG. 5 is a schematic view explanatory of typical lifting computation;

FIG. 6 is a schematic view explanatory of a typical sequence of coefficient data output;

FIG. 7 is a schematic view explanatory of how align units are typically structured;

FIG. 8 is a schematic view explanatory of how data is typically aligned;

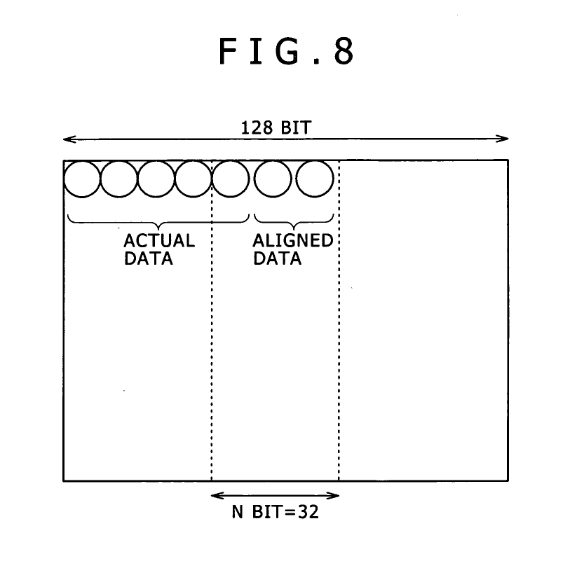

FIG. 9 is a flowchart explanatory of a typical flow of a transmission process;

FIG. 10 is a block diagram showing a major configuration example of a reception apparatus included in FIG. 1;

FIG. 11 is a schematic view explanatory of how data is typically read from a buffer;

FIG. 12 is a flowchart explanatory of a typical flow of a reception process;

FIG. 13 is a flowchart continued from FIG. 12 and explanatory of the flow of the reception process;

FIG. 14 is a flowchart explanatory of a typical flow of a data alignment length determination process; and

FIG. 15 is a block diagram showing a typical composition example of a personal computer to which the present invention is applied.

### DETAILED DESCRIPTION OF THE PREFERRED EMBODIMENTS

The preferred embodiments of the present invention will now be described. The description will be given below under the following headings:

1. First embodiment (transmission/reception system)

2. Second embodiment (personal computer)<

### 1. First Embodiment

### [Configuration of the Transmission/Reception]

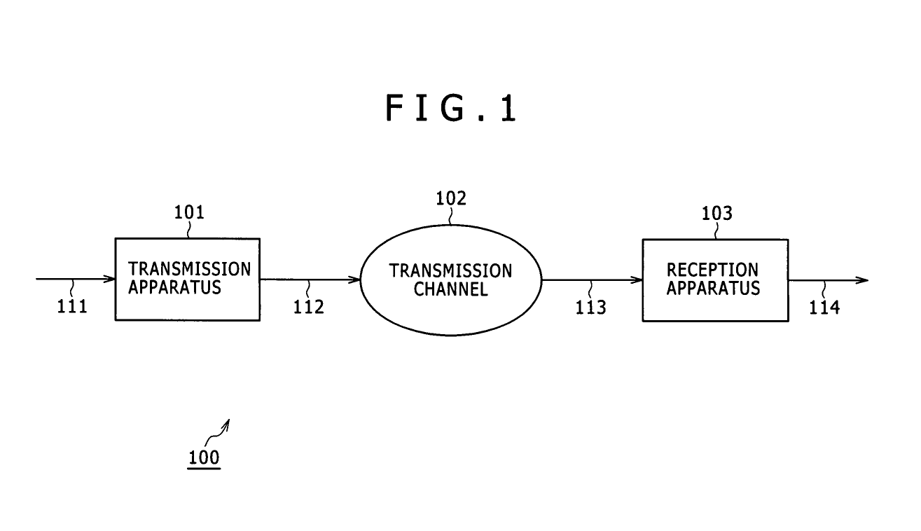

FIG. 1 is a block diagram showing a configuration example of a transmission/reception system 100 to which the present invention is applied.

As shown in FIG. 1, the transmission/reception system 100 includes a transmission apparatus 101, a transmission channel 102, and a reception apparatus 103. The transmission/reception system 100 is a system in which the transmission apparatus 101 and the reception apparatus 103 exchange image data therebetween via the transmission channel 102. The video data captured by the transmission apparatus 101 is encoded in real time, is transmitted to the reception apparatus 103 via the transmission channel 102, and is decoded and reproduced by the reception apparatus 103 in real time.

More specifically, the transmission apparatus 101 encodes image data (indicated by arrow 111) being input (generated), packetizes code streams thus encoded, and transmits the packets (indicated by arrow 112) to the reception apparatus 103 via the transmission channel 102. The reception apparatus 103 receives the packets supplied (indicated by arrow 113) via the transmission channel 102, extracts the encoded code streams from the packets so as to decode the encoded code streams, and outputs the decoded data (indicated by arrow 114).

The transmission apparatus 101 and reception apparatus 103 of the transmission/reception system 100 carry out such data transmissions in real time. In order to be compatible with systems for diverse purposes, the transmission/reception system 100 transmits data in a manner minimizing the time it takes (i.e., delay time) the reception apparatus 103 to output decoded image data.

The transmission channel 102 is typically a network exemplified by the Internet. The transmission channel 102 offers a conduit through which packets are transmitted from the transmission apparatus 101 to the reception apparatus 103. Potentially the transmission channel 102 is an unstable channel over which packet losses may occur.

In such circumstances, the transmission apparatus 101 transmits encoded data in lower-frequency component subbands earlier (i.e., more preferentially) than others as will be discussed later. That is because the lower the frequency of the subbands, the more significantly they affect the quality of images. It follows that the earlier (the more preferentially) the lower-frequency component subbands are transmitted, the longer the tolerable time that can be secured for a retransmission process to deal with packet losses.

The reception apparatus 103 receives the packets transmitted as described above, extracts the encoded data from the received packets, and composes or discards the encoded data in increments of a subband to obtain decoded images.

At this point, the reception apparatus 103 can detect boundaries of subbands more easily to carry out subband-by-subband processing if the transmission apparatus 101 or the reception apparatus 103 itself aligns the encoded code streams beforehand.

What follows is a more specific explanation of the components of the system and the processes or like procedures performed thereby.

### [Composition of the Transmission Apparatus]

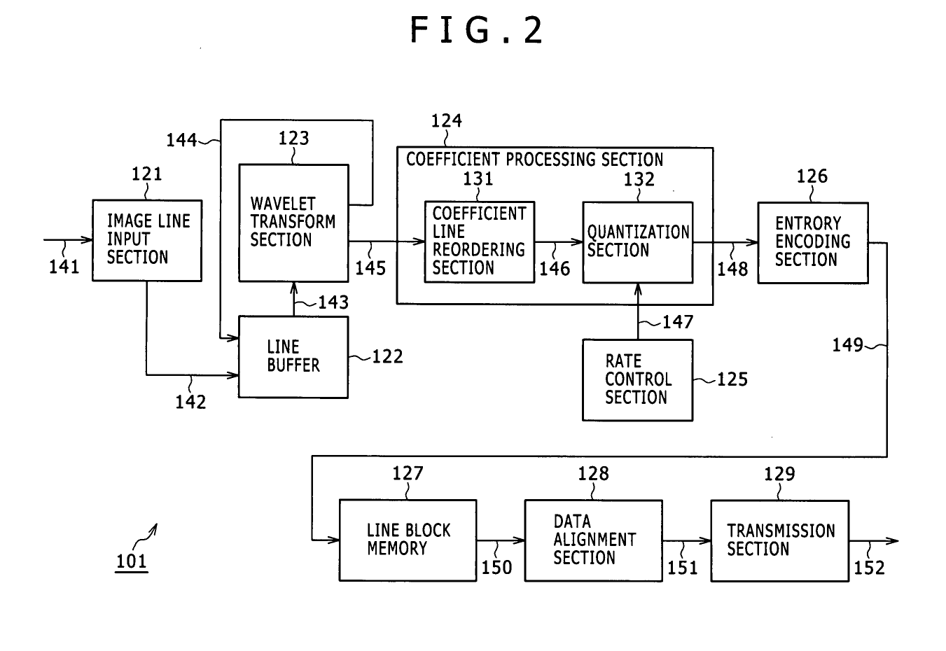

FIG. 2 is a block diagram showing a major configuration example of the transmission apparatus 101 included in FIG. 1.

As shown in FIG. 2, the transmission apparatus 101 typically includes an image line input section 121, a line buffer 122, a wavelet transform section 123, a coefficient processing section 124, a rate control section 125, an entropy encoding section 126, a line block memory 127, a data alignment section 128, and a transmission section 129.

The image line input section 121 supplies input image data (indicated by arrow 141) to the line buffer 122 on a line-by-line basis (indicated by arrow 142). The supplied image data is stored in the line buffer 122. The line buffer 122 holds the image data coming from the image line input section 121 and the coefficient data fed from the wavelet transform section 123, and sends the image data and coefficient data to the wavelet transform section 123 in a suitably timed manner (indicated by arrow 143).

The wavelet transform section 123 performs wavelet transform of the image data and coefficient data supplied from the line buffer 122, thereby generating the coefficient data of the low-frequency and high-frequency components for the next level. Wavelet transform will be discussed later in more detail.

The wavelet transform section 123 supplies the low-frequency component of the generated coefficient data in the vertical and horizontal directions to the line buffer 122 to have the latter retain the supplied data (indicated by arrow 144), and feeds the data of the other components to the coefficient processing section 124 (more particularly, to the coefficient line reordering section 131) (indicated by arrow 145). If the generated coefficient data belongs to the highest level, then the wavelet transform section 123 supplies the coefficient data of the low-frequency component in the vertical and horizontal directions also to the coefficient processing section 124.

The coefficient processing section 124 processes the coefficient data output from the wavelet transform section 123. The coefficient processing section 124 includes the coefficient line reordering section 131 and a quantization section 132.

The coefficient line reordering section 131 is supplied with the coefficient data (coefficient lines) from the wavelet transform section 123 (indicated by arrow 145). The coefficient line reordering section 131 reorders the supplied coefficient data (coefficient lines) into the order in which the data is transmitted.

For example, the coefficient line reordering section 131 is made up of a buffer for holding coefficient lines and a read section for reading the retained lines. That is, the read section reorders the coefficient data by reading the coefficient lines from the buffer in the order in which they are transmitted.

The coefficient line reordering section 131 supplies the coefficient data to the quantization section 132 (indicated by arrow 146).

The quantization section 132 quantizes the coefficient data fed from the coefficient line reordering section 131. The method of quantization may be any appropriate method. Typically, the coefficient data W may be divided by a quantization step size Q, or a common practice represented by the following expression (1):

Quantization coefficient=W/Q (1)

The quantization step size Q above is designated by the rate control section 125. The rate control section 125 estimates the degree of difficulty in encoding images typically on the basis of the amount of the code generated by the entropy encoding section 126. In accordance with the degree of difficulty in encoding, the rate control section 125 designates the quantization step size Q for use by the quantization section 132 (indicated by arrow 147). That is, the rate control section 125 provides rate control over encoded data by designating the quantization step size Q.

The quantization section 132 supplies the quantized coefficient data to the entropy encoding section 126 (indicated by arrow 148).

The entropy encoding section 126 encodes the coefficient data coming from the quantization section 132 using a predetermined entropy encoding method such as Huffman coding or arithmetic coding. The entropy encoding section 126 sends the generated code lines to the line block memory 127 (indicated by arrow 149).

The line block memory 127 holds the encoded data coming from the entropy encoding section 126 in increments of a code line.

The data alignment section 128 reads the encoded data from the line block memory 127 (indicated by arrow 150) while aligning the data in increments of a predetermined data length as needed. The data is forwarded to the transmission section 129 (indicated by arrow 151).

The transmission section 129 packetizes the encoded data supplied from the data alignment section 128, and transmits the packets to the reception section 103 via the transmission channel 102 (indicated by arrow 152).

### [Explanation of Subbands]

What follows is an explanation of wavelet transform carried out by the wavelet transform section 123. Wavelet transform involves recursively repeating analysis filtering for dividing image data into the component of high spatial frequencies (high-frequency component) and the component of low spatial frequencies (low-frequency component), whereby the image data is transformed into coefficient data of hierarchically structured frequency components. In the ensuing description, it is assumed that the higher the component in frequency, the lower the corresponding division level and that the lower the component in frequency, the higher the corresponding division level.

On a given level (as a division level), analysis filtering is carried out in both the horizontal and the vertical directions. That is, analysis filtering is performed first in the horizontal direction and then in the vertical direction. This means that the coefficient data (image data) on a given level is divided by the single-level analysis filtering into four subbands (LL, LH, HL, and HH). The analysis filtering for the next level is carried out on one (LL) of the four generated subbands which is low in frequency in both the horizontal and the vertical directions.

When analysis filtering is repeated recursively as described above, the coefficient data in a band of low spatial frequencies can be isolated into an ever-narrower domain. An efficient encoding process is thus implemented by encoding the coefficient data having undergone the above-described wavelet transform.

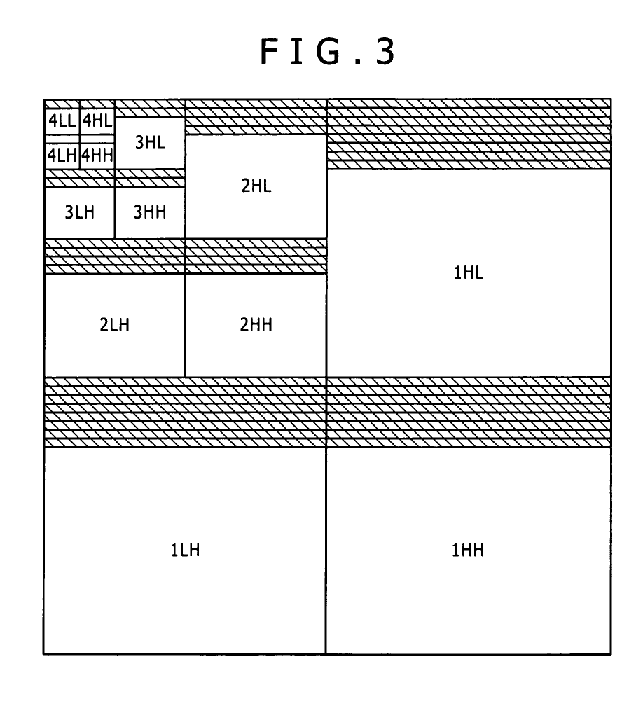

FIG. 3 is a schematic view explanatory of a typical structure of coefficient data generated by repeating analysis filtering four times.

When analysis filtering of division level 1 is performed on baseband image data, the image data is transformed into four subbands (1LL, 1LH, 1HL, and 1HH) of division level 1. Analysis filtering of division level 2 is then carried out on the subband 1LL that is low in frequencies in both the horizontal and the vertical directions, whereby the subband 1LL is transformed into four subbands (2LL, 2LH, 2HL, and 2HH) of division level 2. Analysis filtering of division level 3 is performed on the subband 2LL that is low in frequencies in both the horizontal and the vertical directions, whereby the subband 2LL is transformed into four subbands (3LL, 3LH, 3HL, and 3HH) of division level 3. Analysis filtering of division level 4 is then carried out on the subband 3LL that is low in frequencies in both the horizontal and the vertical directions, whereby the subband 3LL is transformed into four subbands (4LL, 4LH, 4HL, and 4HH) of division level 4.

FIG. 3 shows the structure of coefficient data divided into 13 subbands as described above.

Where analysis filtering is executed as depicted above, two-line image data or coefficient data targeted to be processed is transformed into the coefficient data in four subbands one level higher. Thus as shown by the shaded portions in FIG. 3, the subband 3LL needs two lines, the subband 2LL needs four lines, and the subband 1LL needs eight lines in order for the coefficient data in subbands on division level 4 to be generated line by line. Overall, 16 lines of image data are needed.

As many lines of image data as needed for generating one line of coefficient data in a subband of the lowest-frequency component are collectively called a line block (or precinct). The line block also refers to a set of coefficient data in subbands obtained by performing wavelet transform of the image data in one line block of interest.

In the example of FIG. 3, the image data of 16 lines (not shown) constitutes one line block. A line block may also refer to eight-line coefficient data in subbands on division level 1, four-line coefficient data in subbands on division level 2, two-line coefficient data in subbands on division level 3, and one-line coefficient data in subbands on division level 4.

In a way, the wavelet transform section 123 may be said to perform wavelet transform in increments of the above-described line block. Carrying out wavelet transform in such a manner makes it possible for the coefficient processing section 124 and other sections to start downstream processes before the wavelet transform section 123 subjects the entire image to wavelet transform. That is, the transmission apparatus 101 can encode image data with shorter delays before transmitting the encoded data.

The reception apparatus 103 performs inverse wavelet transform in a manner corresponding to the wavelet transform carried out by the wavelet transform section 123. Specifically, the reception apparatus 103 may start inverse wavelet transform before the entire image is entropy-decoded. That is, the reception apparatus 103 can decode the encoded data with shorter delays before outputting the decoded image data.

In the manner described above, the transmission/reception system 100 can perform data transmissions with appreciably shorter delays than before.

The above-described line block is made up of as many lines as needed for carrying out wavelet transform on a desired division level. This arrangement minimizes the delay time involved in carrying out wavelet transform (inverse wavelet transform).

In the current context, the line refers to a line formed within a picture or a field corresponding to the image data prior to wavelet transform, a line generated within each division level, or a line created within each subband.

The above-described one line of coefficient data (image data) may also be called a coefficient line. If it is necessary to distinguish lines in a more detailed manner, the wording may be varied as needed. For example, one line in a given subband may be referred to as “a coefficient line in a subband”; and one line in all subbands (LH, HL and HH (including LL in the case of the highest level)) on a given level (division level) generated from the same two coefficient lines one level lower may be referred to as “a coefficient line on a given division level (or simply a level).”

In the example of FIG. 3, “a coefficient line on division level 4 (highest level)” refers to one mutually corresponding line in subbands 4LL, 4LH, 4HL, and 4HH (generated from the same coefficient line on division level lower). “A coefficient line on division level 3” refers to one mutually corresponding line in subbands 3LH, 3HL, and 3HH. Also, “a coefficient line in the subband 2HH” refers to one line in the subband 2HH.

Furthermore, one line of encoded data obtained by encoding one coefficient line (i.e., one line of coefficient data) is referred to as a code line as well.

Wavelet transform on division level 4 was explained above in reference to FIG. 3. In the ensuing description, wavelet transform will also be explained basically as performed up to level 4. In practice, however, the number of levels (division levels) for wavelet transform may be determined as desired.

### [5×3 Filter]

What follows is an explanation of analysis filtering.

The wavelet transform process is usually carried out using a filter bank composed of a low-pass filter and a high-pass filter.

As a specific example of wavelet transform, the method involving the use of a 5×3 filter will be explained below.

The impulse response of the 5×3 filter is constituted by a low-pass filter H0(z) and a high-pass filter H1(z) as indicated by the expressions (2) and (3) shown below. These expressions reveal that the low-pass filter H0(z) is a five-tap filter and the high-pass filter H1(z) is a three-tap filter.

H0(z)=(−1+2z−1+6z−2+2z−3−z−4)/8 (2)

H1(z)=(−1+2z−1−z−2)/2 (3)

Using the expressions (2) and (3) above makes it possible directly to calculate the coefficients of the low-frequency and high-frequency components. The calculations of filter processing may be reduced by resorting to the lifting algorithm.

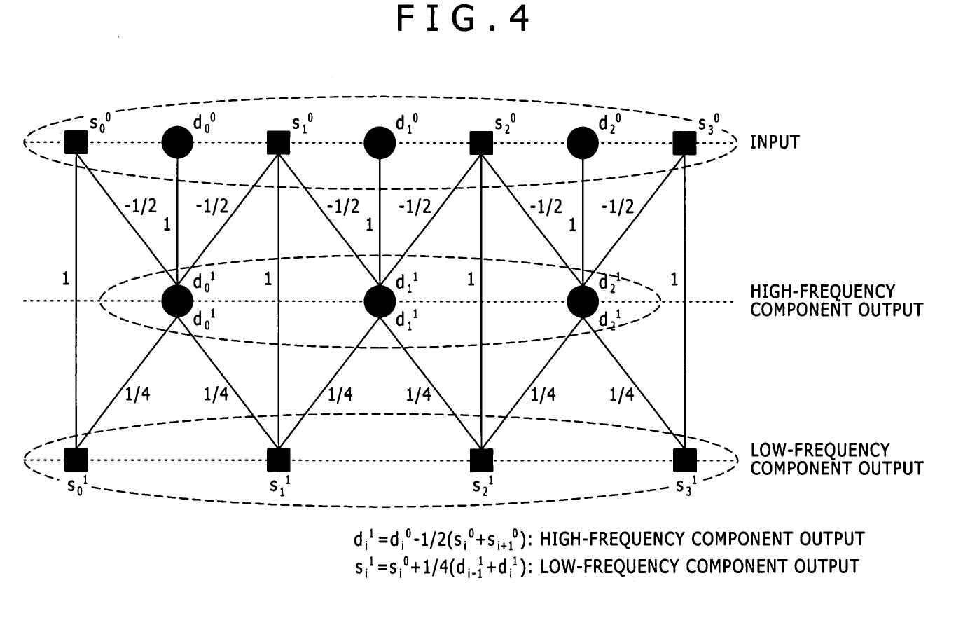

FIG. 4 shows the workings of the 5×3 filter in terms of lifting. In FIG. 4, the topmost row stands for an input signal sequence. The data processing flows from the top of the screen downward. The coefficient of the high-frequency component (high-frequency coefficient) and the coefficient of the low-frequency component (low-frequency coefficient) are output using the following expressions (4) and (5):

di1=di0−½(si0+si+10) (4)

si1=si0+¼(di−11+di1) (5)

### [Lifting Computation]

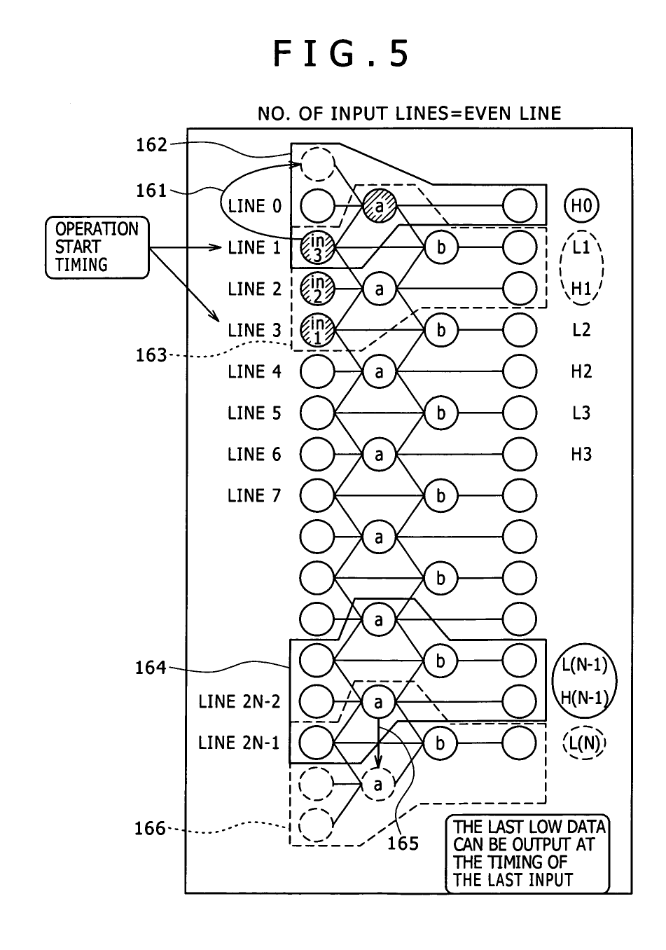

Lifting computation will now be explained. FIG. 5 expresses in terms of lifting the filtering performed on the lines in the vertical direction using the 5×3 analysis filter.

The horizontal direction of FIG. 5 represents the progress of the computation and typical low-frequency and high-frequency coefficients generated thereby. Comparing FIG. 5 with FIG. 4 reveals that the horizontal direction is replaced simply by the vertical direction and that the manner of the computation is identical between the two figures.

At the top of FIG. 5, an arrow 161 shows the highest-level line being symmetrically extended from line 1 to the locations indicated by broken lines, whereby one line is compensated for. As indicated by a frame 162, the added line, line 0, and line 1 are used to perform the lifting computation. A coefficient “a,” which is a high-frequency coefficient (H0), is generated by the computation in step 1.

When line 1, line 2, and line 3 are input, these three lines are used to calculate the next high-frequency coefficient “a,” which is a high-frequency coefficient (H1). Then the first high-frequency coefficient “a” (H0), the second high-frequency coefficient “a” (H1), and the coefficient of line 1 are used to generate a coefficient “b,” which is a low-frequency coefficient (L1). That is, as indicated by a frame 163, the low-frequency coefficient (L1) and high-frequency coefficient (H1) are generated using the three lines (line 1, line 2, and line 3) plus the high-frequency coefficient (H0).

Thereafter, every time two lines are input, the above-described lifting computation is repeated on the subsequent line, whereby the high-frequency coefficient and low-frequency coefficient are output. And when a low-frequency coefficient (L(N−1)) and a high-frequency coefficient (H(N−1)) are generated as indicated by a frame 164, the high-frequency coefficient (H(N−1)) is symmetrically extended as designated by an arrow 165 and the computation is performed as indicated by a frame 166, whereby a low-frequency component (L(N)) is generated.

Shown in FIG. 5 is the example in which the filtering is performed on the lines in the vertical direction. Obviously, the filtering can be performed in the same manner on the lines in the horizontal direction.

The lifting computation described above is carried out on each of the levels involved. It should be noted, however, that analysis filtering is performed in the above-described sequence in which the lower-frequency components are generated more preferentially. The sequence explained above by reference to FIG. 5 shows the relations of dependency between the data subject to analysis filtering; the sequence is different from the actual order of processing.

### [Processing of One Line Block]

The procedure for carrying out analysis filtering will now be explained.

The image data (coefficient data) targeted for processing is processed successively from the topmost line downward of pictures (subbands). The lifting computation of analysis filtering is carried out every time two lines of image data (coefficient data) targeted for processing are prepared (i.e., made ready to be operated on). It should be noted that the lower-frequency subbands are processed more preferentially.

Analysis filtering is carried out using the same procedure on each line block, as will be explained below. What follows is an explanation of the procedure of analysis filtering carried out on the line block every time two lines are prepared (i.e., line block in the steady state).

A line block that includes the upper edge of a picture or a subband in the initial state (i.e., initial-state line block) has a different number of lines necessary for analysis filtering than the other line blocks (steady-state line blocks). However, the procedure of analysis filtering for the initial-state line block is basically the same as that for the steady-state blocks and thus will not be described further.

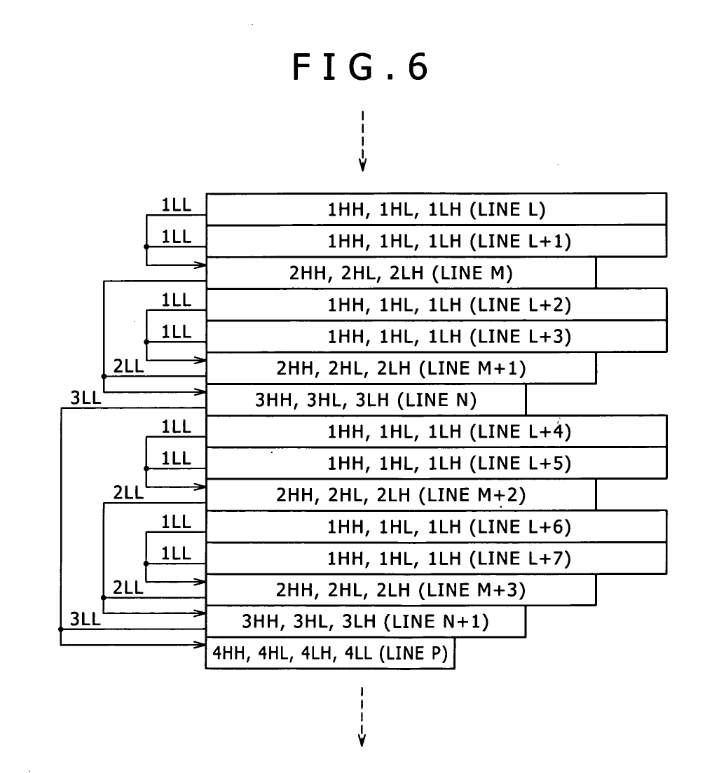

FIG. 6 is a schematic view explanatory of a typical sequence of the output of coefficient data in the steady state. In FIG. 6, the coefficient data having undergone wavelet transform is shown arranged chronologically from the top down.

From a steady-state line block, the topmost two lines constituting baseband image data are first subjected to analysis filtering, whereby Line L of division level 1 (L-th coefficient line from the top) is generated. Since one line of coefficient data cannot be submitted to analysis filtering, the next timing is awaited. At the next timing, the next two lines of the baseband image data are subjected to analysis filtering, whereby line (L+1) of division level 1 ((L+1)th coefficient line from the top) is generated.

At this point, two lines of coefficient data on division level 1 are prepared. These two lines of coefficient data on division level 1 are subjected to analysis filtering of division level 1, whereby line M of division level 2 (M-th coefficient line from the top) is generated. However, one line of coefficient data on division level 2 has been prepared at this point, so that analysis filtering of division level 2 cannot be performed yet. And since the coefficient data of division level 1 is not prepared yet at this point, analysis filtering of division level 1 is also not carried out.

Then the next two lines of the baseband image data are subjected to analysis filtering, whereby line (L+2) of division level 1 ((L+2)th coefficient line from the top) is generated. Because one line of coefficient data cannot be submitted to analysis filtering, the next two lines of the baseband image data are then subjected to analysis filtering, whereby line (L+3) of division level 1 ((L+3)th coefficient line from the top) is generated.

Now that two lines of coefficient data on division level 1 have been prepared, analysis filtering of division level 1 is carried out on these two lines of coefficient data on division level 1, whereby line (M+1) of division level 2 ((M+1)th coefficient line from the top) is generated.

Two lines of coefficient data on division level 2 are then prepared. Analysis filtering of division level 2 is performed at this point on these lines of coefficient data on division level 2, whereby line N of division level 3 (N-th coefficient line from the top) is generated.

In like manner, line (L+4) of division level 1 ((L+4)th coefficient line from the top) is generated, followed by line (L+5) of division level 1 ((L+5)th coefficient line from the top), line (M+2) of division level 2 ((M+2)th coefficient line from the top), line (L+6) of division level 1 ((L+6)th coefficient line from the top), line (L+7) of division level 1 ((L+7)th coefficient line from the top), line (M+3) of division level 2 ((M+3)th coefficient line from the top), and line (N+1) of division level 3 ((N+1)th coefficient line from the top), in that order.

Now that two lines of coefficient data on division level 3 have been prepared, analysis filtering is performed on these two lines of coefficient data on division level 3, whereby line P of division level 4 (P-th coefficient line from the top) is generated.

Analysis filtering is carried out per line block as described above. That is, the above procedure is repeated on each line block. The processing allows the wavelet transform section 123 to carry out analysis filtering of each line block with shorter delays than before. That is, the wavelet transform section 123 can better suppress the increase in delay time attributable to wavelet transform.

### [Align Units]

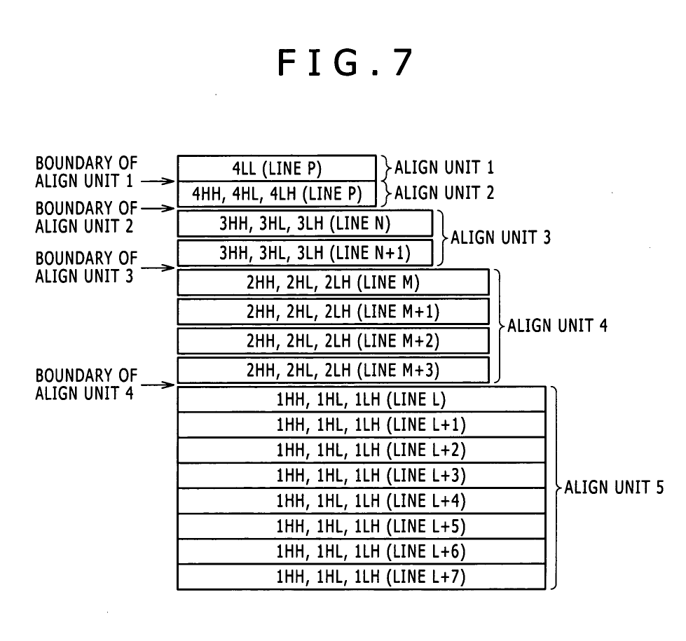

The coefficient lines generated by performing wavelet transform of image data as described above are output by the wavelet transform section 123 in the order in which they were generated. The coefficient lines thus output are reordered by the coefficient line reordering section 131 into the sequence such as one shown in FIG. 7.

In FIG. 7, the time line is shown from the top down. That is, the coefficient lines indicated in FIG. 7 are output from the topmost line downward. More specifically, the coefficient line reordering section 131 reorders the coefficient lines into the sequence in which they are output successively starting from the coefficient line of the lowest-frequency component.

That is, from one line block in the steady state, the coefficient line reordering section 131 first outputs the subband 4LL of line P on division level 4, followed by the subbands 4HH, 4HL and 4LH of line P on division level 4, line N of division level 3, line (N+1) of division level 3, line M of division level 2, line (M+1) of division level 2, line (M+2) of division level 2, line (M+3) of division level 2, line L of division level 1, line (L+1) of division level 1, line (L+2) of division level 1, line (L+3) of division level 1, line (L+4) of division level 1, line (L+5) of division level 1, line (L+6) of division level 1, and line (L+7) of division level 1, in that order.

One or a plurality of coefficient lines discussed above are defined as an align unit. Specifically, the subband 4LL of line P on division level 4 is defined as align unit 1; the subbands 4HH, 4HL and 4LH of line P on division level 4 are defined as align unit 2; line N and line (N+1) on division level 3 are defined as align unit 3; lines M through (M+3) on division level 2 are defined as align unit 4; and lines L through (L+7) on division level 1 are defined as align unit 5.

That is, each align unit is composed of the coefficient lines on each division level. In other words, the align unit is a data unit by which to divide the coefficient lines into division levels. It should be noted, however, that the coefficient lines only in a subband (e.g., 4LL) of the lowest-frequency component still constitute one align unit.

Suitably combining these align units makes it possible to reconstitute images with a resolution that is 1 over 2 to the n-th power of the original image resolution.

For example, there may be cases in which packet losses have occurred during packet transmission or delays have increased during data transmission so that the reconstitution of an image with the same resolution as that of the original image cannot be accomplished in time for reproduction. In such cases, the reception apparatus 103 attempts to reconstitute the image by discarding in increments of an align unit the data of the high-frequency component that cannot be prepared in time for reproduction.

When the above-described arrangement is adopted, the speed of image reproduction is maintained at the expense of a drop in the resolution of the image of interest. If the speed of reproducing individual pictures fluctuates during moving image reproduction, the displayed movements can become jerky and the reproduced image can become considerably awkward to watch. By contrast, since each picture appears in a very short time, the drop in the resolution of an individual picture can be negligible in terms of visual appearance.

By carrying out the above-described control, the reception apparatus 103 can reconstitute images at higher quality than before in a broad sense.

The coefficient lines reordered as explained above are quantized by the quantization section 132, before being encoded by the entropy encoding section 126.

As described, the coefficient lines are reordered in such a manner that the lines of higher resolution levels (in the low-frequency domain) come first followed by those of lower resolution levels (in the high-frequency domain) when subjected to quantization and encoding. This arrangement allows the transmission apparatus 101 to carry out its data transmissions in a manner enhancing the tolerance to the irregularities of the transmission channel 102 (e.g., bandwidth fluctuations and packet losses).

Where systems such as the transmission/reception system 100 in FIG. 1 perform low-delay data transfers, the decoded image data output from the reception apparatus 103 is processed in real time (e.g., so as to display decoded images on a monitor). That is, data transmission and the processing of decoded image data are carried out in parallel.

In the above-described type of low-delay data transmission system, prolonged delays can trigger irregularities in the processing of decoded image data. For example, where decoded images subject to delays are displayed on a monitor, there may be dropping frames or jerky movements on the screen. The tolerable time for data transmission is thus limited to shorter periods.

Under the above-mentioned time constraints, the time is also limited for retransmitting packets that were lost during transmission. In such cases, the later the data is transmitted, the shorter the tolerable time for the retransmissions to make up for packet losses. That is, the later the data is transmitted, the lower the reliability of transmitting the data and the higher the possibility of failing to reconstitute original images.

In other words, the earlier the data is transmitted, the longer the tolerable time for retransmitting packets that were lost. That is, the earlier the data is transmitted, the higher the possibility of successfully reconstituting original images.

As described above, wavelet transform tends to concentrate its energy on the low-frequency component. It follows that the lower the component in frequency, the greater the effect it exerts on eventual image quality.

As discussed above, the transmission apparatus 101 transmits earlier the code lines of the low-frequency component critical for image quality (e.g., on division level 4 in the case of FIG. 3), followed later by the code lines of the high-frequency component which are less critical in terms of the effect on image quality.

In the manner described above, the transmission apparatus 101 raises the possibility of retransmitting more important data (code lines of the low-frequency component) within a predetermined time period. This contributes to further improving the quality of decoded images.

In another example, the transmission rate on the transmission channel 102 may abruptly drop and such a drop may not be followed up immediately by the bit rate control of the encoding process performed by the transmission apparatus 101. In that case, the transmission buffer in use can overflow.

However, by transmitting data of the lower-frequency component earlier (more preferentially) as discussed above, the transmission apparatus 101 discards (i.e., does not send) some code lines of the higher-frequency component. This prevents the buffer from overflowing. As a result, the transmission apparatus 101 can conduct data transmissions without promoting network congestion.

By quantizing and encoding data in the same order in which it is transmitted, i.e., by processing earlier the coefficient lines of the lower-frequency component, the transmission apparatus 101 can not only discard buffer data in the face of the above-mentioned abrupt fluctuations in transmission rate but also omit the quantization and encoding of the unnecessary coefficient lines of the higher-frequency component (e.g., the coefficient lines of the higher-frequency component output from the coefficient line reordering section 131 are discarded). This feature suppresses any unnecessary increase in power dissipation.

The code lines generated by the entropy encoding section 126 are accumulated in the line block memory 127.

### [Alignment]

What follows is an explanation of alignment according to an embodiment of the present invention.

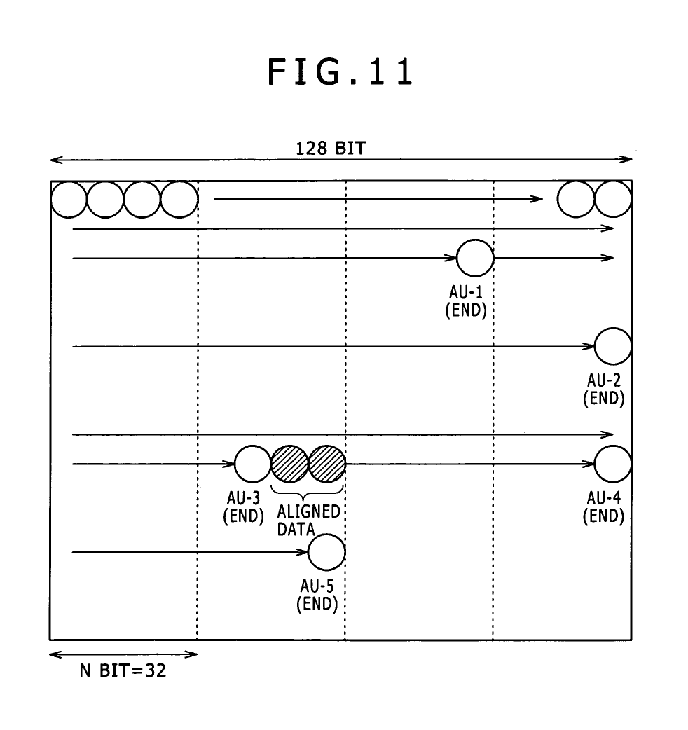

FIG. 11 shows how alignment is typically carried out. The data of each align unit is written to the line block memory 127. The lower the component in frequency, the earlier the align units of that component are written to the memory. Each align unit is stored into the line block memory 127 in such a manner that the beginning of the unit can be identified (so as to identify the data of each align unit).

The data alignment section 128 reads in increments of N bits the data of each align unit stored as described above. The N bits may be called the data alignment length. If the read data falls short of N bits, then the data alignment section 128 retrieves more data to compensate for the lacking bits and makes adjustments so that the data length of the retrieved data becomes N bits.

For example, if the crosswise width of the line block memory 127 is 128 bits, then the data alignment section 128 can determine the data alignment length in this case as 32 bits. The data alignment length N may be chosen as desired.

Aligned data (i.e., added data) is unnecessary and wasteful dummy data. That is, the larger the number of the bits constituting the data alignment length N, the greater the amount of unnecessary data that can increase the load on data transfers. On the other hand, the larger the number of the bits making up the data alignment length N, the smaller the number of memory access operations to be carried out, which will lower the load on data transfers.

It follows that the number of the bits constituting the data alignment length N should preferably be set to a value optimal for the system of interest. The value should therefore be neither too large nor too small to provide for optimally efficient data transfers.

The number of the bits making up the data alignment length may be set equal to a bandwidth W (in bits) of the transmission channel 102. The W-bit bandwidth is assumed to represent an amount of data large enough to permit transmission of the encoded code streams at intervals of a predetermined time period. That is, the W-bit bandwidth is established to deal with the encoded code streams and does not include the amount of the data making up the header of each packet.

The above-described arrangement allows the transmission section 129 to transmit in a predetermined unit time the encoded data supplied in increments of the N-bit data length from the data alignment section 128. This allows the transmission section 129 to reduce the amount of the data in the buffer that accumulates encoded data, whereby the data is transmitted more efficiently than before.

### [Process Flow]

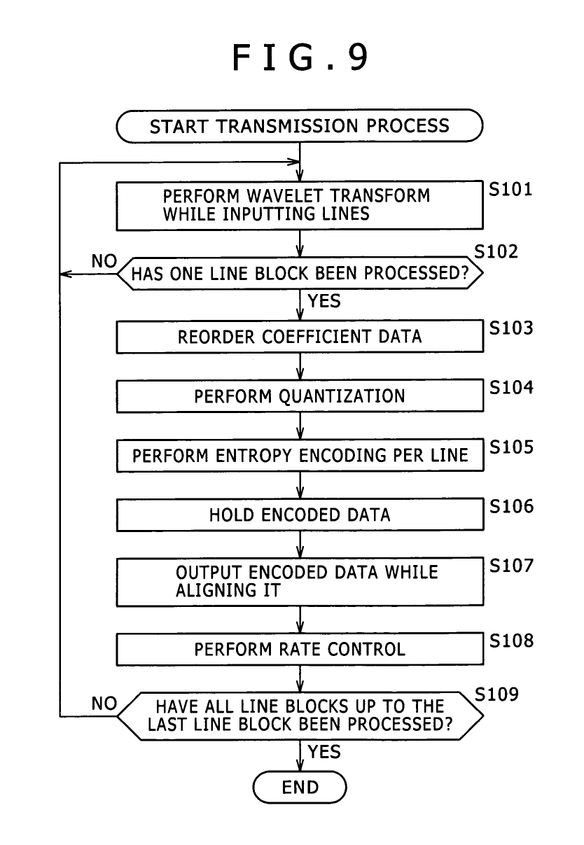

Described below in reference to the flowchart of FIG. 9 is the flow of the transmission process carried out by the transmission apparatus 101 as discussed above.

When the transmission process is started, step S101 is reached. In step S101, the component sections of the transmission apparatus 101 ranging from the image line input section 121 to the wavelet transform section 123 perform wavelet transform while conducting line input.

In step S102, the transmission apparatus 101 determines whether wavelet transform of one line block has been carried out. If one line block is not processed yet, control is returned to step S101 and the subsequent steps are repeated. If in step S102 one line block is determined to have been processed, the transmission apparatus 101 passes control to step S103.

In step S103, the coefficient line reordering section 131 reorders the generated coefficient data from the order in which the data was generated to an order in which the data is sequenced from the lower-frequency component to the higher-frequency component.

In step S104, the quantization section 132 quantizes the reordered coefficient data.

In step S105, the entropy encoding section 126 puts the data to entropy encoding on a line-by-line basis.

In step S106, the line block memory 127 holds the encoded data thus generated and manages the data in increments of an align unit.

In step S107, the data alignment section 128 reads in increments of the N-bit data alignment length the encoded data stored in the line block memory 127 and aligns the retrieved data accordingly. The transmission section 129 packetizes the encoded data thus retrieved and transmits the packets to the reception apparatus 103.

In step S108, the rate control section 125 performs rate control.

In step S109, the transmission apparatus 101 determines whether the last line block has been processed. If the last line block is not determined to be processed yet, control is returned to step S101 and the subsequent steps are repeated. If in step S109 the last line block is determined to have been processed, then the transmission apparatus 101 terminates the transmission process.

As described above, the transmission apparatus 101 aligns the encoded data in increments of the predetermined N-bit data alignment length before transmitting the data. This allows the reception apparatus 103 more easily to detect the boundaries of align units as will be discussed later, whereby control processing is suitably carried out in increments of an align unit.

Alternatively, the transmission apparatus 101 can transmit encoded data without performing any alignment. In this case, the data alignment section 128 reads the encoded data by setting the data alignment length N to zero bit.

### [Structure of the Reception Apparatus]

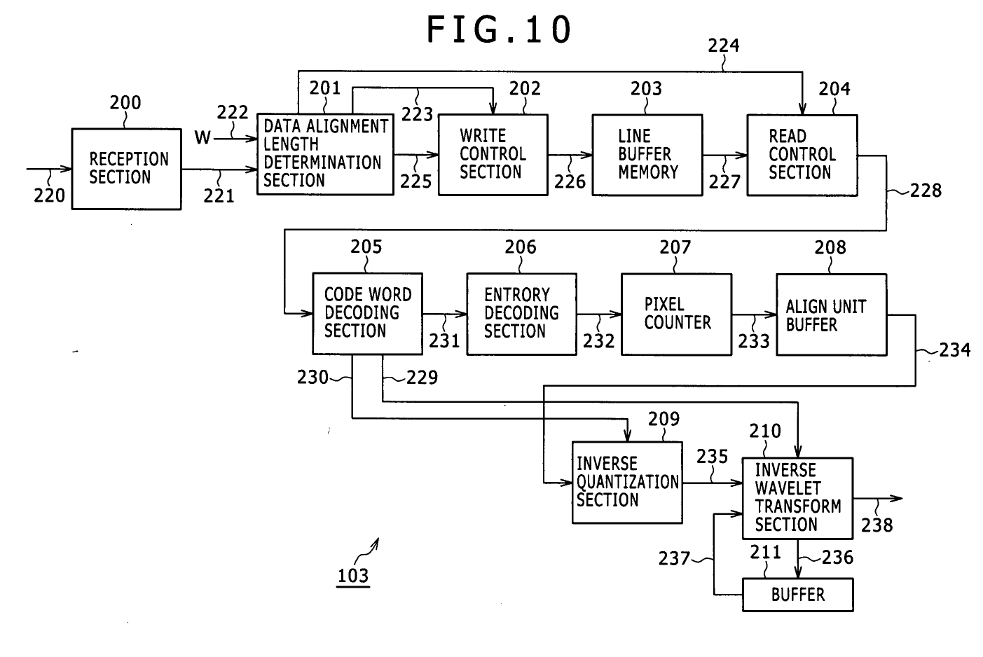

FIG. 10 is a block diagram showing a major configuration example of the reception apparatus 103 included in FIG. 1.

As shown in FIG. 10, the reception apparatus 103 typically includes a reception section 200, a data alignment length determination section 201, a write control section 202, a line buffer memory 203, a read control section 204, a code word decoding section 205, an entropy decoding section 206, a pixel counter 207, an align unit buffer 208, an inverse quantization section 209, an inverse wavelet transform section 210, and a buffer 211.

The reception section 200 receives packets (indicated by arrow 220) supplied from the transmission apparatus 101 via the transmission channel 102, extracts encoded code streams from the received packets, and feeds the extracted streams (indicated by arrow 221) to the data alignment length determination section 201.

Upon receipt of the encoded code streams from the reception section 200, the data alignment length determination section 201 determines the data alignment length N regarding the encoded code streams thus received.

In determining the data alignment length N, the data alignment length determination section 201 acquires the bandwidth W of the transmission channel 102 (indicated by arrow 222) as needed. Information about the bandwidth W may be acquired from any entity that keeps tabs on the bandwidth W of the transmission channel 102 typically by monitoring the transmission channel 102 or the like. For example, the information may be acquired from the reception apparatus 200, from a storage section (not shown) that accommodates the information about the bandwidth W, or from the user or some other person designating the bandwidth.

The data alignment length determination section 201 determines the value of the data alignment length N based on whether align units were formed by the transmission apparatus 101, on whether data alignment was conducted by the transmission apparatus 101, or on the bandwidth W of the transmission channel 102.

For example, if align units were not formed by the transmission apparatus 101, then the data alignment length determination section 201 sets the data alignment length N to zero bit. If the function of resolution scalability is not needed, then it is possible to dispense with align units. For example, there may be cases where resolution scalability is not desired under such constraints as the limited capability of the transmission apparatus 101 or of the reception apparatus 103.

Where there exist no align units as mentioned above, it is not necessary to detect the boundaries of align units. That means there is no need for data alignment. In that case, the data alignment length determination section 201 sets the data alignment length N to zero bit so as not to increase the amount of unnecessary data.

As another example, if align units exist but no alignment is carried out by the transmission apparatus 101, the data alignment length determination section 201 sets the data alignment length N in a manner prompting the write control section 202 to perform the alignment. In this case, the data alignment length determination section 201 sets the data alignment length N to the W-bit bandwidth of the transmission channel 102 so that the encoded code streams extracted from the received packets may be written to the line buffer memory 203 more efficiently than otherwise.

The W-bit bandwidth is assumed to denote an amount of data large enough to permit transmission of the encoded code streams by the transmission channel 102 at intervals of a predetermined time period as mentioned above. The W-bit bandwidth is thus established to deal with the encoded code streams and does not include the amount of the data making up the header of each packet.

When the bandwidth W of the transmission channel 102 is used as the data alignment length N, the data length of the encoded code streams extracted from the packets received at intervals of the unit time is utilized unchanged as the N-bit data alignment length. That means the write control section 202 can conduct alignment in increments of the unit time.

For example, at the end of an align unit, the data length of the encoded code streams obtained in the unit time can fall short of W bits. Since the data alignment length N is W bits long, the write control section 202 need only carry out alignment in such a manner that the data length of the encoded code streams acquired in the current unit time becomes W bits.

That is, by setting the data alignment length N to the bandwidth W of the transmission channel 102, the write control section 202 can perform alignment more efficiently than otherwise.

Alternatively, it is possible to make the data alignment length N shorter than the bandwidth W of the transmission channel (N<W). Still, it is preferable to conduct alignment using the longest possible data length. This makes it possible to reduce the number of access operations on the buffer and thereby improve the efficiency of processing.

Conversely, if the data alignment length N were made longer than the bandwidth W of the transmission channel 102, that would make the alignment computation more complicated, which is not preferable.

As another example, if there exist align units and if the transmission apparatus 101 has performed alignment, then the data alignment length determination section 201 sets the data alignment length N to a data alignment length N′ specific to the transmission apparatus 101.

That is, where the transmission apparatus 101 has carried out alignment, setting the data alignment length N to the currently effective data alignment length N′ allows the write control section 202 to write the encoded code stream of each align unit to the line buffer memory 203 by practically dispensing with alignment. In other words, the write control section 202 can perform write operations more efficiently than before.

The data alignment length determination section 201 feeds the determined data alignment length N to the write control section 202 and read control section 204 (indicated by arrows 223 and 224). Also, the data alignment length determination section 201 supplies the encoded code streams to the write control section 202 (indicated by arrow 225).

The write control section 202 writes the supplied encoded code streams to the line buffer memory 203 (indicated by arrow 226) while carrying out alignment as needed using the N-bit data alignment length determined by the data alignment length determination section 201.

FIG. 11 shows how align units are written to the line buffer memory 203.

As shown in FIG. 11, the encoded coded streams in increments of an align unit (AU) are written successively to the line buffer memory 203 from the beginning. Where the encoded code streams were already aligned by the transmission apparatus 101, the data length of the encoded code streams in align units is an integer multiple of N bits.

For example, the data length is an integer multiple of N (e.g., 32) bits for an encoded code stream of align unit (AU-1), an encoded code stream of align unit 2 (AU-2), an encoded code stream of align unit 4 (AU-4), and an encoded code stream of align unit 5 (AU-5).

These encoded code streams need not be aligned by the write control section 202.

Where alignment was not carried out by the transmission apparatus 101, it might happen that the data length is not an integer multiple of N bits, as in the case of the data length for the encoded code stream of align unit 3 (AU-3) shown in FIG. 11.

In the case above, the write control section 202 aligns the encoded code streams in increments of N bits before writing the streams to the line buffer memory 203.

That is, where align units exist, the data length of the encoded code stream of each align unit is an integer multiple of the N-bit data alignment length.

Returning to FIG. 10, the read control section 204 reads the encoded code streams from the line buffer memory (indicated by arrow 227) in increments of the data alignment length N determined by the data alignment length determination section 201.

As described above, the read control section 204 need only read the encoded code streams in increments of the data alignment length N. This reduces the number of access operations on the line buffer memory 203 and allows the encoded code streams to be retrieved from the memory more efficiently than before. Also, because the boundary of each align unit coincides with the read increment, the detection of the boundary of each align unit becomes easy.

The read control section 204 supplies the encoded code streams thus retrieved to the code word decoding section 205 (indicated by arrow 228). If it becomes necessary to discard align units of the high-frequency component due to prolonged delays or packets getting lost, the read control section 204 detects the boundaries of align units based on the data alignment length N and determines whether or not to discard the encoded code stream of each align unit being detected.

That is, the read control section 204 supplies only the encoded code streams of necessary align units to the code word decoding section 205 and discards the encoded code streams of unnecessary align units (i.e., does not sends the code streams to the latter).

The code word decoding section 205 decodes the encoded code streams, extracts information such as quantization step size and resolution level of wavelet transform from the decoded streams, and sends the extracted information to the inverse quantization section 209 and inverse wavelet transform section 210 (indicated by arrows 229 and 230).

After completing the decoding, the code word decoding section 205 supplies the encoded code streams thus decoded to the entropy decoding section 206 (indicated by arrow 231).

The entropy decoding section 206 entropy-decodes the encoded code streams using a predetermined variable length decoding method corresponding to the variable length encoding method adopted by the entropy encoding section 126 of the transmission apparatus 101. The entropy decoding section 206 sends the coefficient data obtained through entropy decoding to the pixel counter 207 (indicated by arrow 232).

Where the above-described align units exist, the inverse wavelet transform section 210 performs composite filtering while identifying each align unit. That is, even with regard to the coefficient data obtained through entropy decoding, it is necessary to identify each align unit.

The pixel counter 207 counts the number of coefficient data of each align unit. The pixel counter 207 takes hold of the pixel count of each align unit (AU) in advance. When the first pixel of align unit 1 (AU-1) is input, the pixel counter 207 starts counting the pixels. From the count value, the pixel counter 207 detects the boundary of each align unit.

Upon detecting the boundary of an align unit, the pixel counter 207 supplies the coefficient data of the pixels counted up so far to the align unit buffer 208 and causes the buffer 208 to store the data therein (indicated by arrow 233).

The inverse quantization section 209 reads the coefficient data from the align unit buffer 208 in increments of an align unit in a suitably timed manner (indicated by arrow 234).

The align unit buffer 208 stores the coefficient data in such a manner that the stored data may be identified for each align unit. That is, the coefficient data stored in the align unit buffer 208 is managed so that each align unit can be identified.

Thus the inverse quantization section 209 can readily read the coefficient data from the align unit buffer 208 in increments of an align unit (only the coefficient data of the desired align unit can be retrieved; there is no need to read the coefficient data from the beginning).

The inverse quantization section 209 inversely quantizes the acquired coefficient data in increments of an align unit, and feeds the inversely quantized data to the inverse wavelet transform section 210 (indicated by arrow 235).

The inverse wavelet transform section 210 performs the composite filtering process on the supplied coefficient data using its composite filter. By utilizing the buffer 211, the inverse wavelet transform section 210 repeats the composite filtering process recursively (indicated by arrows 236 and 237) to obtain decoded image data. The inverse wavelet transform section 210 outputs the decoded image data thus acquired to the outside (indicated by arrow 238).

### [Process Flow]

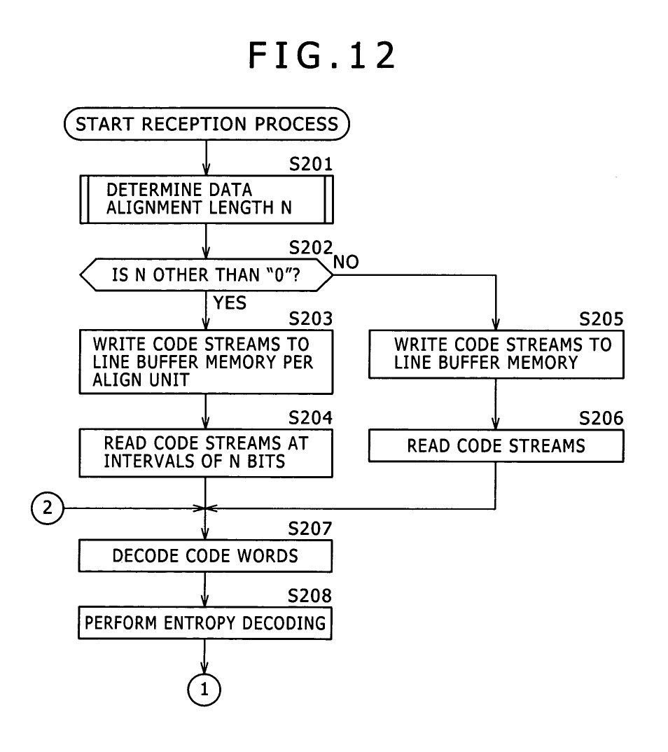

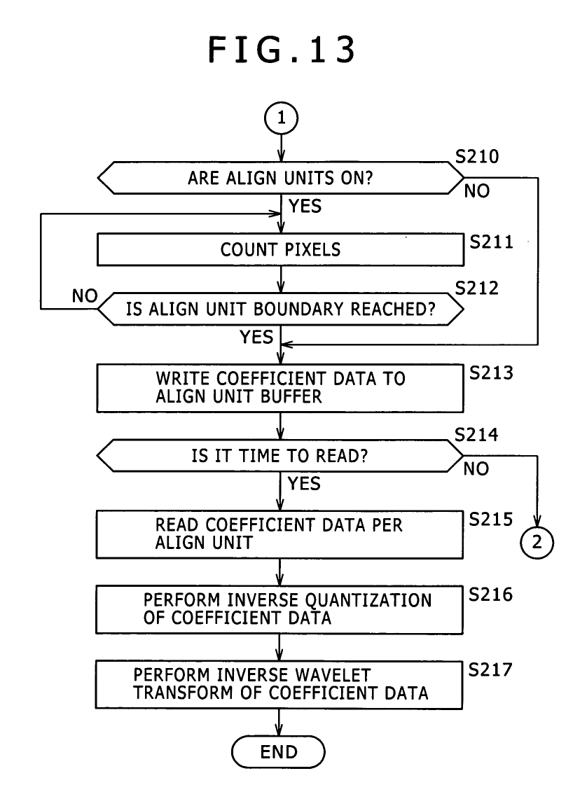

A typical flow of the above-described reception process performed by the reception apparatus 103 is explained below by reference to the flowcharts of FIGS. 12 and 13.

When packets are received and the reception process is started, step S201 is reached. In step S201, the data alignment length determination section 201 determines the data alignment length N.

In step S202, the reception apparatus 103 determines whether the value of the data alignment length N is other than “0.” If the value of the data alignment length N is determined to be other than “0,” control is passed on to step S203. If the value of the data alignment length N is determined to be “0,” then control is passed on to step S205.

If the data alignment length N is other than “0,” the write control section 202 in step S203 writes the encoded code streams to the line buffer memory 203 in increments of an align unit while performing alignment as needed. In step S204, the read control section 204 reads the encoded code streams from the line buffer memory 203 in increments of N bits.

If the data alignment length N is “0,” then the write control section 202 in step S205 writes the supplied encoded code streams successively to the line buffer memory 203. In step S206, the read control section 204 reads the encoded code streams from the line buffer memory 203 in the order in which they were written thereto.

Upon completion of step S204 or S206, the reception apparatus 103 passes control to step S207.

In step S207, the code word decoding section 205 decodes code words. In step S208, the entropy decoding section 206 decodes the encoded code streams. Control is then passed on to step S210 in FIG. 13.

In step S210 in FIG. 13, the pixel counter 207 determines whether align units exist (i.e., whether they are ON) based typically on information included in the encoded code streams. If align units are determined to exist (they are ON), then control is passed on to step S211.

In step S211, the pixel counter 207 counts the pixels of the coefficient data. In step S212, the pixel counter 207 determines whether the counted pixels constitute the boundary of an align unit. If the counted pixels are not determined to be the boundary of an align unit, then step S211 is reached again and the subsequent steps are repeated.

If in step S212 the counted pixels are determined to be the boundary of an align unit, then the pixel counter 207 passes control to step S213.

If in step S210 align units are determined not to exist (they are not ON), then the pixel counter 207 passes control to step S213.

In step S213, the pixel counter 207 writes the coefficient data of which the pixels have been counted or the supplied coefficient data to the align unit buffer 208.

In step S214, the inverse quantization section 209 determines whether read timing is reached for the coefficient data. If the read timing is determined to be reached, the inverse quantization section 209 passes control to step S215. In step S215, the inverse quantization section 209 reads the coefficient data from the align unit buffer 208 in increments of an align unit. In step S216, the inverse quantization section 209 inversely quantizes the coefficient data thus retrieved.

In step S217, the inverse wavelet transform section 210 submits the inversely quantized coefficient data to inverse wavelet transform. When the inverse wavelet transform process is completed, the reception process is brought to an end.

If in step S214 the read timing is not determined to be reached, the inverse quantization section 209 returns control to step S207 in FIG. 12. The subsequent steps are then repeated.

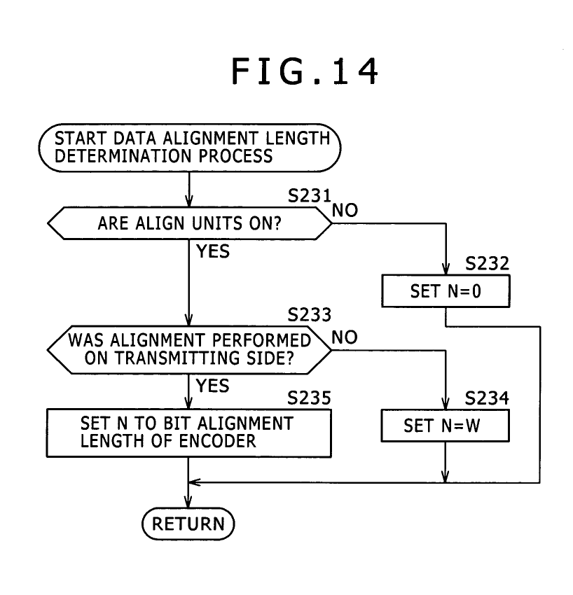

A typical flow of the data alignment length determination process performed in step S201 of FIG. 12 is explained below by reference to the flowchart of FIG. 14.

When the data alignment length determination process is started, the data alignment length determination section 201 determines whether align units exist (i.e., whether they are ON). If align units are determined not to exist (they are not ON), then the data alignment length determination section 201 goes to step S232 and sets the data alignment length N to “0.” With the data alignment length N thus established, control is returned to step S201 in FIG. 12 and the subsequent steps are carried out.

If in step S231 of FIG. 14 align units are determined to exist (they are ON), then the data alignment length determination section 201 goes to step S233 and determines whether alignment was carried out on the transmitting side.

If alignment is determined not to have been performed on the transmitting side, the data alignment length determination section 201 goes to step S234 and sets the value of the data alignment length N to the bandwidth W of the transmission channel 102. With the data alignment length N thus established, control is returned to step S201 in FIG. 12 and the subsequent steps are carried out.

If in step S233 of FIG. 14 alignment is determined to have been carried out on the transmitting side, then the data alignment length determination section 201 goes to step S235 and sets the value of the data alignment length N to the data alignment length N′ established by the transmission apparatus 101. With the data alignment length N thus established, control is returned to step S201 in FIG. 12 and the subsequent steps are carried out.

When the reception apparatus 103 performs alignment in increments of an appropriate data length as described above, it becomes easier to detect the boundaries of align units and to process the align units individually. This feature enables the reception apparatus 103 to improve more easily its tolerance to the packet losses during data transmission thereby realizing low-delay data transmissions in a manner suppressing image quality degradation.

### 2. Second Embodiment

### [Personal Computer]

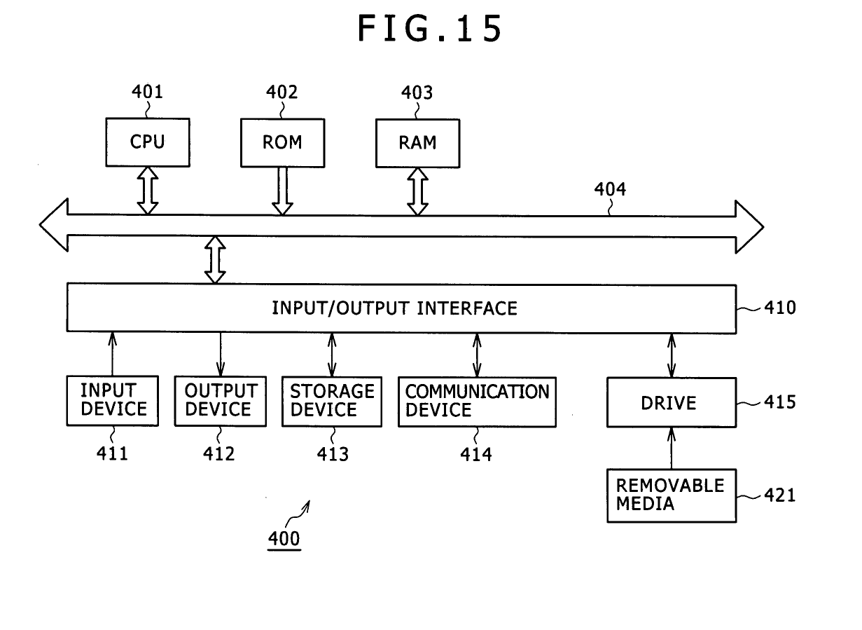

The series of steps or processes described above may be executed either by hardware or by software. In such cases, the personal computer such as one shown in FIG. 15 may be used for the implementation of these steps or processes.

In FIG. 15, a CPU (central processing unit) 401 of a personal computer 400 performs various processes in accordance with the programs stored in a ROM (read only memory) 402 or in keeping with the programs loaded from a storage device 413 into a RAM (random access memory) 403. Also, the RAM 403 may accommodate data needed by the CPU 401 in carrying out its diverse processing.

The CPU 401, ROM 402, and RAM 403 are interconnected via a bus 404. An input/output interface 410 is also connected to the bus 404.

The input/output interface 410 is connected with an input device 411, an output device 412, a storage device 413, and a communication device 414. The input device 411 is made up of a keyboard, a mouse and the like; the output device 412 is composed of a display such as a CRT (cathode ray tube) or an LCD (liquid crystal display); the storage device 413 is formed by an SSD (solid state drive) such as a flash memory and/or a hard disk; and the communication device 414 is constituted by an interface for interfacing with a wired LAN (local area network) or a wireless LAN and by a modem. The communication device 414 conducts communications over networks including the Internet.

A drive 415 is connected as needed to the input/output interface 410. A piece of removable media 421 such as a magnetic disk, an optical disk, a magneto-optical disk, or a semiconductor memory may be loaded into the drive 415. The computer programs read from the loaded medium are installed as needed into the storage device 413.

Where the above-described series of steps or processes is to be carried out by software, the programs constituting the software may be installed upon use from a suitable network or from appropriate recording media.

As shown in FIG. 15, the recording media that hold these programs are distributed to users not only as the removable media 421 apart from their computers and constituted by magnetic disks (including flexible disks), optical disks (including CD-ROM (compact disc-read only memory) and DVD (digital versatile disc)), magneto-optical disks (including MD (Mini-disc)), or semiconductor memories, the media carrying the programs offered to the users; but also in the form of the ROM 402 or the hard disk in the storage device 413, the medium accommodating the programs and incorporated beforehand in the users' computers.

Also, the programs for execution by the computer may be processed in the depicted sequence of this specification (i.e., on a time series basis), in parallel, or in otherwise appropriately timed fashion such as when they are invoked.

In this specification, the steps describing the programs stored on the recording media represent not only the processes that are to be carried out in the depicted sequence (i.e., on a time series basis) but also processes that may be performed parallelly or individually and not necessarily chronologically.

In this specification, the term “system” refers to an entire configuration made up of a plurality of component devices.

The structure explained as a single device (or processing section) in the foregoing description may also be constituted by a plurality of devices (or processing sections). Conversely, the structured explained above as a plurality of devices (or processing sections) may be constituted collectively by a single device (or processing section). Also, the above-described devices (or processing sections) may be supplemented individually or collectively with a structure or structures not discussed above. Furthermore, part of the structure of a given device (or processing section) may be included in the structure of some other device (or processing section) as long as the system as a whole functions in a substantially unchanged manner. Thus it is to be understood that changes and variations may be made to the above-described embodiments of the present invention without departing from the spirit or scope of the claims of the invention that follow.

For example, the present invention may be applied advantageously to apparatuses whereby moving image signals, video signals, or still images are compressed and transmitted so as to be received and expanded into images for output. Specifically, the invention can be adapted to mobile communication devices, teleconference systems and surveillance camera/recorder systems, as well as to such applications as remote medical care and diagnosis, video compression and transmission inside the broadcasting station, distribution of live images, interactive communications between students and their teacher, wireless transmission of still and moving images, and interactive video games, among others.

What is claimed is:

1. An image processing apparatus comprising:
analysis filtering means for transforming a line block into coefficient data decomposed into frequency bands by performing an analysis filtering process hierarchically, said line block including image data of as many lines as needed for generating the coefficient data of at least one line in a subband of the lowest-frequency component;
encoding means for encoding said coefficient data generated by said analysis filtering means; and
alignment means for aligning, in increments of a predetermined data length, the encoded data obtained by encoding said coefficient data by said encoding means.

2. The image processing apparatus according to claim 1, further comprising encoded data reordering means for reordering said encoded data from the order in which an output stemming from said analysis filtering process was carried out by said analysis filtering means, to an order in which said encoded data is ordered from the lowest-frequency component upward.

3. An image processing method for use with an image processing apparatus having analysis filtering means, encoding means and alignment means, said image processing method comprising the steps of:
causing said analysis filtering means of said image processing apparatus to transform a line block into coefficient data decomposed into frequency bands by performing an analysis filtering process hierarchically, said line block including image data of as many lines as needed for generating the coefficient data of at least one line in a subband of the lowest-frequency component;
causing said encoding means of said image processing apparatus to encode the generated coefficient data; and
causing said alignment means of said image processing apparatus to align, in increments of a predetermined data length, the encoded data obtained by encoding said coefficient data.

4. An image processing apparatus comprising:
determination means for determining a data alignment length constituting the data length by which to align encoded data generated by encoding a line block made up of a group of coefficient data in subbands including at least one line of coefficient data in a subband of the lowest-frequency component, said coefficient data being composed of image data of a predetermined number of lines decomposed into frequency bands by performing an analysis filtering process hierarchically;
alignment means for aligning said encoded data in increments of said data alignment length determined by said determination means;
storage means for storing said encoded data aligned by said alignment means;
read means for detecting from said encoded data in said storage means boundaries of align units each serving as a data unit by which to decompose said encoded data into division levels of said analysis filtering process, said read means further reading only the encoded data of a necessary align unit from said storage means in increments of said data alignment length; and
decoding means for decoding said encoded data read by said read means from said storage means.

5. The image processing apparatus according to claim 4, further comprising composite filter means for transforming said coefficient data in subbands into said image by carrying out a composite filtering process hierarchically, said coefficient data in subbands having been obtained by said decoding means through decoding.

6. The image processing apparatus according to claim 5, further comprising count means for counting the number of pixels of said coefficient data in subbands obtained by said decoding means through decoding;
wherein said decoding means transforms said coefficient data in subbands into said image data based on the boundaries of said align units detected in accordance with the number of pixels counted by said count means.

7. The image processing apparatus according to claim 4, wherein said determination means determines said data alignment length based on whether or not said align units exist in said encoded data, on whether or not said encoded data has been aligned previously, and on the bit width of a transmission channel on which said encoded data is transmitted.

8. The image processing apparatus according to claim 7, wherein, if said align units are found to exist in said encoded data and if said encoded is found to have been aligned previously, then said determination means determines the data alignment length used in the previous alignment as said data alignment length.

9. The image processing apparatus according to claim 7, wherein, if said align units are found to exist in said encoded data and if said encoded data is not found to have been aligned previously, then said determination means determines the bit width of said transmission channel as said data alignment length.

10. The image processing apparatus according to claim 7, wherein, if said align units are not found to exist in said encoded data, then said determination means determines said data alignment length as zero bit.

11. An image processing method for use with an image processing apparatus having determination means, alignment means, storage means, read means and decoding means, said image processing method comprising the steps of:
causing said determination means of said image processing apparatus' to determine a data alignment length constituting the data length by which to align encoded data generated by encoding a line block made up of a group of coefficient data in subbands including at least one line of coefficient data in a subband of the lowest-frequency component, said coefficient data being composed of image data of a predetermined number of lines decomposed into frequency bands by performing an analysis filtering process hierarchically;
causing said alignment means of said image processing apparatus to align said encoded data in increments of said data alignment length having been determined;
causing said storage means of said image processing apparatus to store said encoded data having been aligned;
causing said read means of said image processing apparatus to detect from the stored encoded data boundaries of align units each serving as a data unit by which to decompose said encoded data into division levels of said analysis filtering process, said read means being further caused to read only the encoded data of a necessary align unit in increments of said data alignment length; and
causing said decoding means of said image processing apparatus to decode said encoded data having been read.

12. An image processing apparatus comprising:
an analysis filtering section configured to transform a line block into coefficient data decomposed into frequency bands by performing an analysis filtering process hierarchically, said line block including image data of as many lines as needed for generating the coefficient data of at least one line in a subband of the lowest-frequency component;
an encoding section configured to encode said coefficient data generated by said analysis filtering section; and
an alignment section configured to align, in increments of a predetermined data length, the encoded data obtained by encoding said coefficient data by said encoding section.

13. An image processing apparatus comprising:
a determination section configured to determine a data alignment length constituting the data length by which to align encoded data generated by encoding a line block made up of a group of coefficient data in subbands including at least one line of coefficient data in a subband of the lowest-frequency component, said coefficient data being composed of image data of a predetermined number of lines decomposed into frequency bands by performing an analysis filtering process hierarchically;
an alignment section configured to align said encoded data in increments of said data alignment length determined by said determination section;
a storage section configured to store said encoded data aligned by said alignment section;
a read section configured to detect from said encoded data in said storage section boundaries of align units each serving as a data unit by which to decompose said encoded data into division levels of said analysis filtering process, said read section further reading only the encoded data of a necessary align unit from said storage section in increments of said data alignment length; and
a decoding section configured to decode said encoded data read by said read section from said storage section.
